(19) United States
(12) Patent Application Publication
(10) Pub. No.: US 2012/0276261 A1
(43) Pub. Date: Nov. 1, 2012

(54) Method for identifying drinks using marking device

(76) Inventor: Jason Kahng, Toronto (CA)

(21) Appl. No.: 13/094,899

(22) Filed: Apr. 27, 2011

(51) Int. Cl. A23P 1/00

(52) U.S. Cl. 426/383

(57) ABSTRACT

At a party/gathering, people are served drinks in identical vessels (children's cups, beer bottles, wine glasses . . .) and it is very difficult to determine whose drink is whose. Mark cups, glasses, and bottles with the drink-marking device (special purpose drink marker) to identify drink ownership. And when the party is over, apply cooking oil to marks 5 minutes before cleaning/putting into dishwasher for a mark-free glass that is ready to use at the next party.

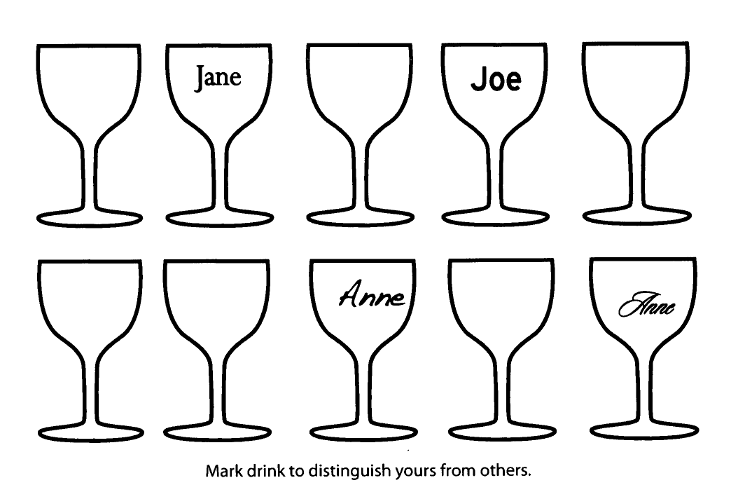

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

How many times have you been to a party, put down your drink only to forget which one is yours? Like most people, you will search for yours but probably end up getting another one because all of the glasses and bottles are the same. Mark cups, glasses, cans and bottles with the drink-marking device (special purpose drink markers) and never lose your drink again.

### BRIEF SUMMARY OF THE INVENTION

You are at your sister's son's birthday party. Everyone is served out of identical wine glasses or has the same beer. Put yours down and you risk losing track of which is yours. Mark it with the drink-marking device (special purpose drink markers) to identify which drink is yours.

### BRIEF DESCRIPTION OF THE SEVERAL VIEWS OF THE DRAWING

The diagrams show how writing your name on your drink distinguishes it from someone else's drink even if the same type of drinking vessel is used, and even if people share the same name, because the style of writing is personal to everyone.

### DETAILED DESCRIPTION OF THE INVENTION

At a party/gathering, people are served drinks in identical vessels (children's cups, beer bottles, wine glasses . . .) and it is very difficult to determine whose drink is whose. People often put their drinks down to talk to people/get food/go to the washroom and come back some time later to find there are several drinks that could be their. Like most others, they just end up getting another drink and the host ends up collecting the dozens of half-full misplaced drinks at the end of the night.

Now, there is a solution to this old problem of misplaced drinks. When hosting a party, supply the fast drying, non-toxic, special purpose drink markers so that guests can keep track of their cups, glasses, cans and bottles. Marks dry almost instantly and don't come off on hands.

And after the party, apply cooking oil to marks 5 minutes before cleaning/putting into dishwasher for a mark-free cup/glass. Marks on hard-surface drinking vessels (glass, ceramic, plastic, metal) are removable with normal household cooking oil.

Superior to other drink marking devices in that: You don't forget which color band/charm you are; young children don't swallow the otherwise dangerous choking hazard (wine charms); storage of marking device is easy (put special purpose drink markers in wine glass and have them ready for the next party).

Superior to other drink marking devices in that: They work on all hard-surface drinking vessels from wine glasses to beer bottles, to soda cans. You don't need a variety of them for various drinks (wine vs. beer bottles/cans vs. tumblers . . .)

Superior to other drink marking devices in that: special purpose drink markers allow guests to be creative with their markings and really personalize their drink containers.

1. (canceled)

2. A unique permanent marker product for marking glass and plastic food and drink receptacles

3. The marks made with product are removable with cooking oil
